(19) United States
(12) Patent Application Publication
(10) Pub. No.: US 2006/0275738 A1
(43) Pub. Date: Dec. 7, 2006

(54) Method for increasing maxillary bone mass, and apparatus for use therein

(76) Inventor: Dennis Flanagan, Mansfield, CT (US)

Correspondence Address: IRA S. DORMAN, 330 ROBERTS STREET, SUITE 200, EAST HARTFORD, CT, 06108, US

(21) Appl. No.: 11/142,067

(22) Filed: Jun. 1, 2005

(51) Int. Cl. A61C 5/00

(52) U.S. Cl. 433/215

(57) ABSTRACT

The method employs a syringe, fitted with a nozzle for depositing a bone slurry material into a void formed between the maxillary bone surface and the overlying sinus lining, the bone slurry material hardening to increase the mass and volume of the maxillary bone so as to thereby reinforce and better adapt the site for the receipt of a dental implant.

### BACKGROUND OF THE INVENTION

Following tooth extraction from the maxilla, the maxillary sinus pneumaticizes and expands, ultimately causing bone resorption. As a result, the remaining bone mass and volume may be inadequate to permit secure and durable placement of a dental implant at the site.

### SUMMARY OF THE INVENTION

Accordingly, it is a broad object of the present invention to provide a method for increasing the amount of bone available for the placement of dental implants at a maxilla extraction site, and to provide apparatus that is effective in performing such a method.

More specific objects of the invention are to provide such a method and apparatus wherein and whereby a bone slurry is effectively introduced at the intended implant site.

It has now been found that certain of the foregoing and related objects of the invention are attained by the provision of apparatus for introducing a bone slurry to a site between a maxillary bone and the overlying sinus lining, the apparatus comprising: a body having a material-containment chamber, with an outlet port; force-generating means for expressing material from the body chamber through the outlet port; and a nozzle member attached, preferably disengagably, to the body adjacent the outlet port and having a tubular part providing a conduit for the flow of material. The nozzle member includes a contact element, normally taking the form of a cap or piece disposed transversely over the outer end of the tubular part, remote from the body, and it defines adjacent openings that are of sufficient area to permit the passage of a bone slurry material flowing through the conduit.

The body of the apparatus will usually be a syringe body having an elongate chamber extending thereinto and terminating at the outlet port, with the force-generating means comprising an elongate plunger member disposed for axial displacement in the body chamber. The syringe body and plunger member will preferably be matingly threaded, so that axial displacement of the plunger member is effected by relative rotation, and matingly threaded interengaging means may also be provided to enable disengagable attachment of the nozzle member to the body. The contact piece on the outer end of the tubular part will advantageously comprise a disk element, and a plurality of peripherally spaced strut elements will be provided for attaching the disk element to the tubular part.

In the preferred and most effective embodiments of the invention, the apparatus will additionally include means for effecting vibration therein, such means normally being electrically powered and desirably taking the form of an ultrasound or piezoelectric head. When employed in a syringe assembly, the means for effecting vibration will most effectively be operatively attached to the plunger.

In most instances the tubular part on the nozzle member will be cylindrical and will have an outside diameter that is significantly larger than the diameter of a contact disk element thereon. The tubular part may be provided with exterior indicia for gauging the depth of insertion into a formed hole, and it will most desirably include an enlarged, insertion-limiting abutment element disposed adjacent the body.

Other objects of the invention are attained by the provision of a method for increasing maxillary bone mass and volume at a dental-implant site. As an initial step (normally following suitable assessment and preparation steps), a hole is formed in the maxilla, at an implant site, to such a depth as to leave a thin section of bone remaining adjacent the overlying sinus lining. The thin bone section is then circumferentially weakened and fractured, to thereby produce a bone disk. The tubular part of a nozzle member, of the character described, is inserted, outer end first, into the hole that is formed into the maxillary bone, so as to cause the contact element to bear against the bone disk. A bone slurry material is then introduced through the conduit and openings of the nozzle member, so as to hydraulically displace the bone disk into the sinus lining, while simultaneously gently separating the lining from the bone (without breaching or tearing the lining) and depositing the bone slurry into the void that is formed; these steps are most effectively achieved with the assistance of vibratory forces transmitted to the bone slurry. The method of the invention will normally include steps of: radiographically measuring the thickness of maxillary bone at the implant site, between the maxillary ridge crest and the adjacent sinus lining, prior to forming the hole therein; measuring the sinus volume, to facilitate estimation of the amount of bone slurry material needed; and radiographically determining the position of the delivery tube, prior to injection of bone slurry material, to ensure that an optimal size nozzle member is being employed.

### BRIEF DESCRIPTION OF THE DRAWINGS

FIG. 1 is an exploded elevational view of apparatus embodying the present invention, a portion of which is broken away to show internal structural features;

FIG. 2 is an elevational view showing a nozzle member suitable for use in the apparatus of the invention, drawn to a scale greatly enlarged from that of FIG. 1;

FIG. 3 is a leading-end view of the nozzle member depicted in FIG. 2;

FIG. 4 is a diagrammatic representation of a maxilla site showing, in several stages, steps performed in carrying out the method of the invention; and

FIG. 5 is a schematic representation showing the apparatus of the invention used in performing the method hereof.

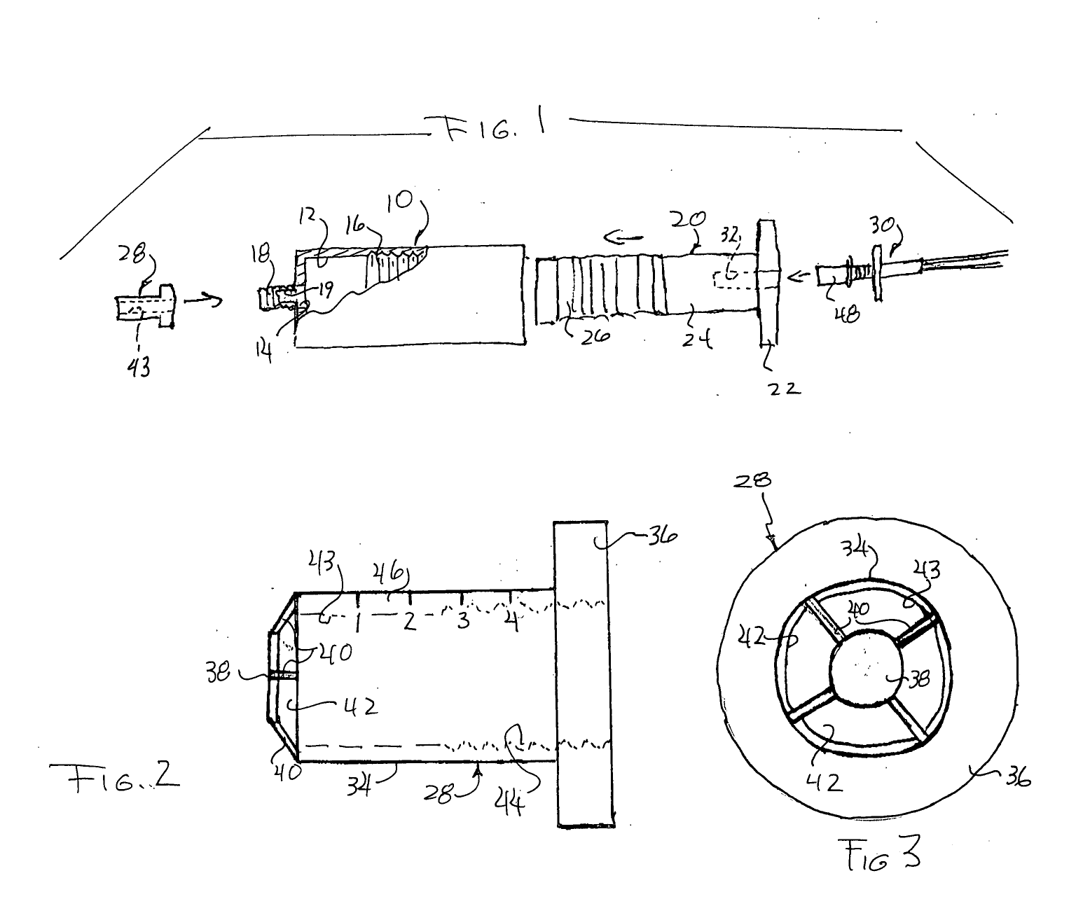

### DETAILED DESCRIPTION OF THE PREFERRED EMBODIMENTS

Turning now in detail to the appended drawings, therein illustrated is apparatus embodying the present invention and including a syringe body, generally designated by the numeral 10, having an internal cylindrical chamber 12 with an outlet port 14 at one end. The inside surface of the wall defining the body 10 has a threaded portion 16, adjacent its entrance end, and a threaded nipple 18 surrounds the outlet port 14 and has a passage 19 in flow communication therewith.

The syringe assembly also includes a plunger, generally designated by the numeral 20, comprised of a shaft 24 with a head portion 22 at one end. The shaft 24 has a threaded portion 26 which is dimensioned and configured for mated engagement with the threaded internal portion 16 of the syringe body 10. As will be appreciated, rotation of the plunger 24, in one direction or the other, will effect extension and retraction of the plunger into and out of the chamber 12 in a gradual and highly controllable manner. A nozzle member, generally designated by the numeral 28, is threadably engaged on the nipple 18 that extends from the body 10, and a piezoelectric vibration unit, generally designated by the numeral 30, includes a functional head 48 (and unnumbered electrical conductors) that is seated, during use, within a cavity 32 formed into the outer end of the plunger 20.

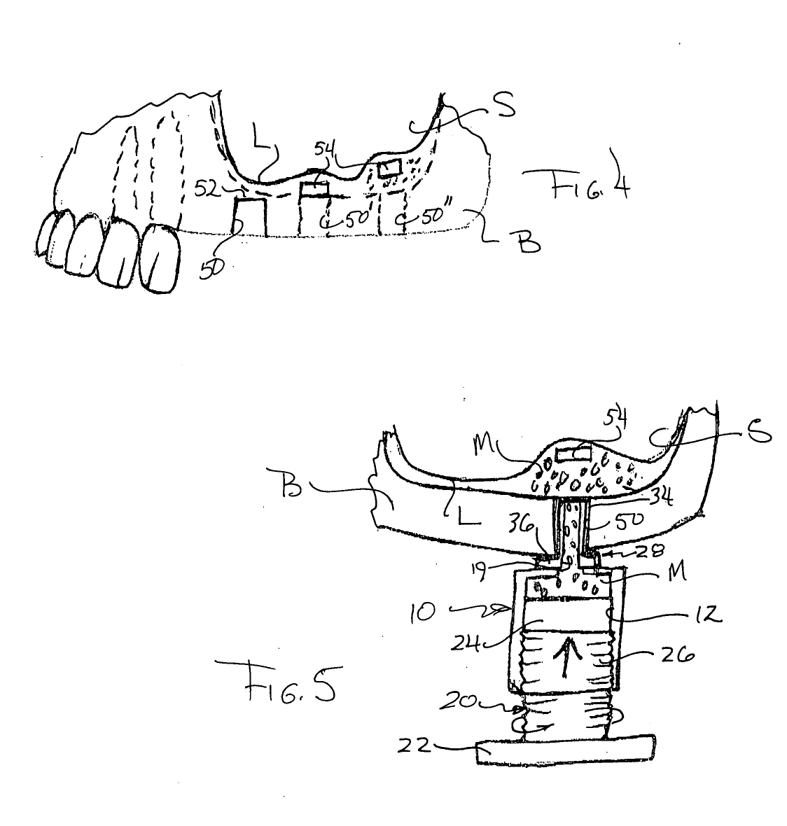

As is best seen in FIGS. 2 and 3, the nozzle member 28 includes a tubular part 34 having an enlarged abutment collar 36 at one end and a contact cap or disk 38 at the opposite end, the disk 38 being supported by four struts 40 between which openings 42 are defined for the outward flow of material passing through the conduit 43. A threaded section 44 extends through the collar 36 and into the tubular part 34, and serves to permit disengageable assembly of the nozzle member 28 with the threaded nipple 18 provided on the syringe body 10. A portion of the tubular part 34 is marked with lines at measured intervals (e.g., of 1 mm), to provide an effective depth gauge.

The method of the invention is best understood by reference to FIGS. 4 and 5 of the drawings. More particularly, FIG. 4 shows (for illustration purposes only) three blind holes 50, 50′, 50″ drilled into the maxilla “B” and extending to such a depth as to leave a thin bone section 52, typically 1 to 2 mm thick. The bone section at the inner end of hole 50′ has been trephined and infractured, to produce a bone disk 54 which is, at the end of hole 50″, displaced slightly into the lining “L” of the sinus “S”, producing a slight bulge into the sinus cavity.

Displacement of the bone disk 54 is effected by use of the apparatus of the invention, hereinabove described. To do so, the tubular part 34 of the nozzle member 28 is inserted into the drilled hole 50′ so as to cause the contact disk 38 to engage the bone disk 54, using the reference indicia of the marked portion 46 for guidance. Carefully controlled injection of bone slurry material M, achieved by turning of the plunger 24 and assisted and enhanced by the vibratory effects of the piezoelectric unit 30, displaces the bone disk 54 against the sinus lining L and, in turn, gently separates the sinus lining L from the bone area surrounding the hole 50″ and distends the lining (without tearing or otherwise breaching it) slightly into the cavity of the sinus S; the injected bone slurry M fills the void that is formed between the separated lining L and the bone B. The ultimate depth of insertion of the tubular part 34 is limited by the abutment collar 36 on the nozzle member, which serves not only to prevent entry of the tubular part 34 into the sinus but also to seal the sinus cavity from the oral cavity.

Prior to commencement of the drilling operation, it will be appreciated that a periapical radiograph would normally be made to enable measurement of the dimension between the ridge crest and the sinus S, so as to demonstrate the amount of bone remaining in the maxilla at the intended implant site. After local anesthesia is administered, a full thickness flap would then be cut and raised to expose the maxillary ridge that underlies the sinus. A drill would then be used to remove a suitable amount of bone (as previously described), followed by circumferential weakening, using a trephine drill, and loosening of the bone disk so formed, using an osteotome.

The radiograph initially made enables a preliminary selection, among several sizes, to choose a nozzle member having a tubular part 34 that is of suitable length, relative to the thickness of the maxilla. A second radiograph would however also normally be made, with the selected nozzle member emplaced in the drilled hole, to determine whether a different nozzle member, having a longer of shorter tubular part, should be substituted. When it is established that the correct nozzle member has been selected, the chamber 12 of the syringe body 10 would be filled with an appropriate amount of bone slurry material M, based upon the volume of the sinus cavity calculated from measured dimensions, and the body 10 would be threaded onto the nozzle member 28. The bone slurry M is then extruded under the sinus lining L, in the manner described, following which the apparatus is removed. After sufficient hardening of the bone slurry M, a dental implant may be installed.

It will be appreciated that many variations may be made in the apparatus of the invention, as will be evident to those skilled in the art. For example, the slurry-containing body and the force-generating means employed need not be constructed using a syringe set, and virtually any functionally equivalent apparatus or system may be substituted. Indeed, it is possible that the force-generating means may be hydraulically driven or pneumatic, and the nozzle member, its manner of attachment, and its particular features (e.g., the contact element, which may simply be a projecting post), may vary substantially from the form and arrangement shown. Similarly, the specific and ancillary method steps may deviate substantially from those described hereinabove. Any suitable bone slurry material may be used in the practice of the invention, and a variety of such products are commercially available and are known to those skilled in the art; for example, PUROS, available from the Zimmer Corporation, and BIO OSS, available from the Osteohealth company.

Thus, it can be seen that the foregoing and related objects of the present invention are attained by the provision of a method for increasing the amount of bone available for the placement of dental implants at a maxilla extraction site, and by the provision of apparatus that is effective in carrying out such a method. More specifically, the invention provides a novel method and apparatus wherein and whereby a bone slurry is efficiently and effectively introduced at the intended implantation site.

Having thus described the invention, what is claimed is:

1. Apparatus for introducing a bone slurry to a site between a maxilla and the overlying sinus lining, comprising:
a body having a material-containment chamber, with an outlet port;
force-generating means for expressing material from said body chamber through said outlet port; and
a nozzle member disengageably attached to said body adjacent said outlet port and having a tubular part providing a conduit for the flow of material passing through said outlet port from said body chamber, said nozzle member including a contact element, effectively disposed in a substantially fixed position over the outer end of said tubular part, remote from said body, and defining openings, adjacent said contact piece, that are of sufficient area to permit the passage of a bone slurry material flowing through said conduit of said tubular part.

2. The apparatus of claim 1 wherein said body is a syringe body; wherein said chamber is of elongate form, and extends into said body and terminates at said outlet port; and wherein said force-generating means comprises an elongate plunger member disposed for axial displacement in said body chamber.

3. The apparatus of claim 2 wherein said syringe body and said plunger member are matingly threaded, such that axial displacement of said plunger member is effected by rotation thereof relative to said syringe body.

4. The apparatus of claim 1 wherein said contact element of said nozzle member comprises a contact piece disposed transversely over said outer end of said tubular part.

5. The apparatus of claim 4 wherein said contact piece comprises a disk element and a plurality of peripherally spaced strut elements, said strut elements operatively attaching said disk element to said tubular part of said nozzle member.

6. The apparatus of claim 5 wherein said tubular part of said nozzle member is cylindrical, and wherein said disk element is of a diameter that is substantially smaller than the outside diameter of said tubular part.

7. The apparatus of claim 1 wherein said tubular part of said nozzle member is provided with exterior indicia for gauging the depth of insertion of said tubular part into a formed hole.

8. The apparatus of claim 1 wherein said nozzle member additionally includes an enlarged abutment element, disposed adjacent said body, for limiting the depth of insertion of said tubular part into a formed hole.

9. The apparatus of claim 1 wherein said body and said nozzle member have interengaging elements thereon that are matingly threaded to enable such disengageable attachment of said nozzle member to said body.

10. The apparatus of claim 1 additionally including means for effecting vibration therein.

11. The apparatus of claim 10 wherein said means for effecting vibration is electrically powered, and is attached to said pressure means.

12. The apparatus of claim 11 wherein said means for effecting vibration comprises an ultrasound or piezoelectric head, wherein said body is a syringe body, and wherein said force-generating means is a syringe plunger operatively assembled therewith.

13. Apparatus for introducing a bone slurry to a site between a maxillary and the overlying sinus lining, comprising:
a body having a material-containment chamber, with an outlet port;
force-generating means for expressing material from said body chamber through said outlet port;
a nozzle member attached to said body adjacent said outlet port and having a tubular part providing a conduit for the flow of material passing through said outlet port from said body chamber, said nozzle member including an enlarged abutment element disposed adjacent said body; and
means for effecting vibration in said apparatus.

14. A method for increasing maxillary bone volume at a dental-implant site, comprising the steps:
forming a blind hole in the maxillary bone, at an implant site, to such a depth as to leave a thin section of bone adjacent the overlying sinus lining;
circumferentially weakening and fracturing said thin bone section to thereby produce a bone disk, and displacing said bone disk into the adjacent sinus lining;
providing a nozzle member comprised of a tubular part having a conduit for the flow of bone slurry;
inserting said tubular part of said nozzle member, outer end first, into said hole formed into said maxillary bone at said implant site to such depth as to cause said nozzle member to engage said bone disk; and
injecting a bone slurry material through said conduit of said nozzle member so as to urge said bone disk into said sinus lining, without breach thereof, and so as to deposit said slurry material between said maxillary bone and said adjacent sinus lining.

15. The method of claim 14 wherein said apparatus of claim 1 is employed for effecting said bone slurry material injecting step, and provides said nozzle member.

16. The method of claim 14 wherein vibratory force is effectively applied to said bone slurry material during said injecting step.

17. The method of claim 14 additionally including a preliminary step of measuring the thickness of said maxillary bone at said implant site, between the maxillary ridge crest and said adjacent sinus lining, effected prior to said step of forming said hole therein.
